(19) United States
(12) Patent Application Publication
(10) Pub. No.: US 2003/0145331 A1
(43) Pub. Date: Jul. 31, 2003

(54) Modifying content retrieved from a set-top box

(76) Inventors: George D. Escobar, Purcellville, VA (US); Carlos A. Silva JR., Potomac, MD (US); Robert M. Cooper, Arlington, VA (US)

Correspondence Address: FISH & RICHARDSON P.C., 1425 K STREET, N.W., 11TH FLOOR, WASHINGTON, DC, 20005-3500, US

(21) Appl. No.: 10/059,274

(22) Filed: Jan. 31, 2002

(51) Int. Cl. H04N 7/173; H04N 5/445

(52) U.S. Cl. 725/110; 725/37; 725/70

(57) ABSTRACT

To help viewers access content of interest, the viewer's interactions with the set top box may be monitored and analyzed. Content may be assembled, generated, produced, and edited for presentation to a viewer based on the monitored and analyzed viewer interactions. As a result, content of interest to the viewer may be identified and made accessible without any additional effort or knowledge required by the viewer.

This application claims priority from U.S. application Ser. No. 09/584,348, filed Jun. 1, 2000, and titled “Managing Electronic Content from Different Sources,” and U.S. application Ser. No. 09/828,469, filed Apr. 9, 2001, and titled “Contextual Programming,” both of which are incorporated by reference.

### TECHNICAL FIELD

This invention relates generally to set top boxes and in particular to determining and presenting content of interest to viewers of set top boxes.

### BACKGROUND

As the amount of content available to viewers continually grows, it will become increasingly important for a viewer to easily locate and access content that is of interest to the viewer. Television (TV) content providers have created electronic program guides (EPGs) that help viewers locate TV programming content. Typically, an EPG database of TV programming information is downloaded to a processor connected to a TV. The processor accesses the database and the TV displays an overview of the programming available at a particular date and time. Using the EPG, a viewer can determine the date and time associated with a particular TV program. In addition, the viewer may view information about TV programming and select TV programming. Because of the large and increasing number of channels available to viewers EGPs are becoming more difficult to use. In addition, EPGs typically do not provide viewers with a way to locate and access content other than TV programming content that may be of interest to the viewer, which is of increasing significance as TV becomes more interactive.

### SUMMARY

To help a viewer access content of interest, the viewer's interactions with the set top box may be monitored and analyzed. Content may be assembled, generated, produced, and edited for presentation to a viewer based on the monitored and analyzed viewer interactions. As a result, content of interest to the viewer may be identified and made accessible without any additional effort or knowledge required by the viewer.

In one general aspect, content is provided to a viewer by receiving a signal from a set top box, determining a viewer command associated with the signal, analyzing the viewer command to determine and identify content of potential interest to the viewer, and assembling the content for presentation to the viewer. A trigger may be generated to indicate that the assembled content is available for viewing. The trigger is sent to the set top box and activated when the content should be presented to a viewer. The trigger may be activated in response to viewer interaction with the set top box.

In another general aspect, a system for providing content to a viewer includes an interface and a host. The interface receives signals from a set top box. The host determines a viewer command associated with the signals. The host then analyzes the viewer command to determine content of potential interest to the viewer. Next, the host assembles the content for presentation to the viewer, generates a trigger to indicate that the assembled content is available for viewing and sends the trigger to the set top box. Finally, the host receives a signal from the set top box to access the content and sends the content to the set top box in response to the signal.

In another general aspect, content is presented to a viewer by receiving a viewer command, sending the viewer command to be analyzed, and receiving content based on the analyzed viewer command. The content is selected based on analysis of the viewer command to determine and identify content of potential interest to the viewer.

A trigger may be received to indicate that the content is available for viewing. An indication that the content is available is displayed when the trigger is activated. The trigger may be activated in response to viewer interaction with the set top box.

A memory of the set top box may be accessed to retrieve the content for display. In addition, a signal to request the content may be sent to a host, and the content may be received from the host.

In another general aspect, a set top box includes a display interface for outputting display data, an input for receiving a viewer command, a command interface for sending the viewer command to be analyzed, a content interface for receiving content, and a processor causing the content to be displayed using the display interface. The content may be selected based on analysis of the viewer command to determine and identify content of potential interest to the viewer.

The processor may receive a trigger to indicate that the content is available for viewing. The processor may send to the display interface an indication that the content is available when the trigger is activated. The trigger may be activated in response to viewer interaction with the set top box.

The processor may receive a signal from a viewer command input to access the content. In response, the processor may send the content to the display interface for display. A memory may store the content. The processor may access the memory to retrieve and display the content. In addition, the processor may send a signal to request the content from a host. The requested content may be received by the content interface for display by the processor.

Other features and advantages will be apparent from the description, the drawings, and the claims.

### DESCRIPTION OF DRAWINGS

FIG. 1 is a block diagram of an exemplary set top box system.

FIG. 2 is a block diagram of an exemplary set top box of the system of FIG. 1.

FIG. 3 is a flow chart of a method that may be implemented by the system of FIG. 1.

FIGS. 4A and 4B are exemplary screen shots of the display of an indication of available content in response to activation of a trigger.

FIGS. 5 and 6 are exemplary screen shots of the display of content identified from analyzing viewer commands.

Like reference symbols in the various drawings indicate like elements

### DETAILED DESCRIPTION

System Overview

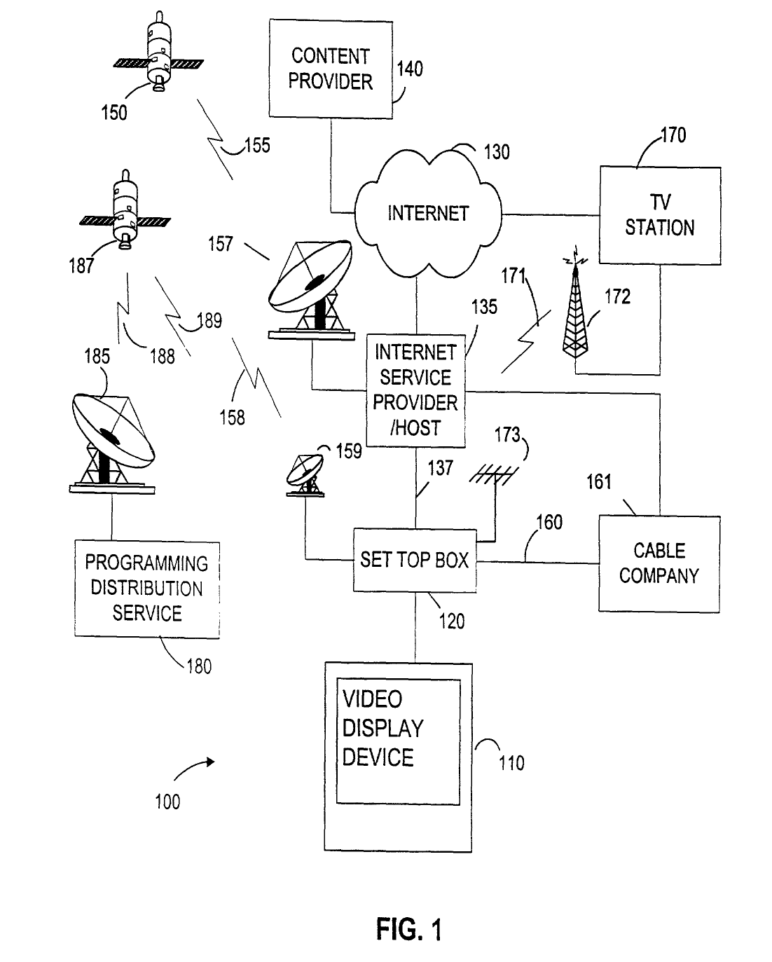

An exemplary set top box system 100, as shown in FIG. 1, includes a video display device 110 connected to a set top box 120. The video display device 110 may be implemented using, for example, an analog TV, a digital TV, a high definition TV (HDTV), a video monitor, or another device capable of displaying analog and/or digital video signals.

The set top box 120 gathers and manages content for presentation on the video display device 110. The set top box 120 generally gathers and manages two primary types of content: web content and TV content. Web content includes, for example, digital information that is typically, but not exclusively, communicated over a communications network. Examples of web content include a web page, an image file, an audio file, a video file, a data file, a program, an e-mail message, an instant message, and a chat session. TV content may include digital and analog information intended for presentation on a video display device that generally corresponds to established standards, such as, for example, European Telecommunications Standards Institute (ETSI), Digital Video Broadcasting (DVB), Advanced Television Systems Committee (ATSC), or European Cable Communications Association (ECCA). Examples of TV content include a broadcast TV program, a satellite TV program, a cable TV program, output of a video camera, or output of a video player/recorder device, such as, for example, a videocassette recorder (VCR), a laser disc player, or a digital videodisk (DVD) player, or output of a video camera.

The set top box 120 may use a variety of methods to gather web and TV content. The set top box 120 can be configured to receive web content from, for example, an ultra high frequency (UHF) transmitter, a very high frequency (VHF) transmitter, a digital transmitter, a radio frequency (RF) transmitter, a satellite transmitter, a cable TV provider, and the Internet 130. For example, the set top box 120 can access web content over the Internet 130 through a connection to an Internet service provider (ISP) or host 135, such as America Online (AOL™). The set top box 120 connects to the host 135 through a wired or wireless communications link 37 (e.g., a plain old telephone service (POTS), a digital subscriber line (DSL), or an integrated systems digital network (ISDN)) that typically is provided by a telecommunications company. Once connected to the host 135, the set top box 120 can gather web content from any number of content providers 140 connected to the Internet 130. Although shown as a single entity in FIG. 1, the host 135 may include one or more computers, processors, servers, and other equipment for performing various functions associated with the ISP.

The set top box 120 also can access web content from a satellite 150. The satellite 150 receives the web content from an uplink 155 provided by a transmitter 157 connected to, for example, the host 135. The web content is provided to the set top box 120 through a downlink 158 from the satellite 150 to a receiving dish 159. Similarly, the set top box 120 may receive web content through a cable communications link 160 connected to a cable company 161. Web content also may be inserted in the vertical blanking interval (VBI) of a TV signal (e.g., broadcast, cable, or satellite). Examples of using the VBI to send web content to the set top box 120 are described in U.S. application Ser. No. 09/584,347 filed Jun. 1, 2000, and titled “Online/Offline Triggers,” which is incorporated by reference.

The set top box 120 may receive TV content from a number of sources. For example, a TV station 170 may broadcast UHF and VHF TV signals 171 from a TV transmitter tower 172. An antenna 173 connected to the set top box 120 receives the TV signals 171. Likewise, a TV programming distribution service 180 (e.g., Direct TVTM) can transmit TV content from a transmitter 185 to a satellite 187 for transmission to the receiving dish 159 connected to the set top box 120 using an uplink 188 and a downlink 189. TV content also may be provided directly to the set top box 120 by the cable company 161 using cable communications link 160.

Set Top Box

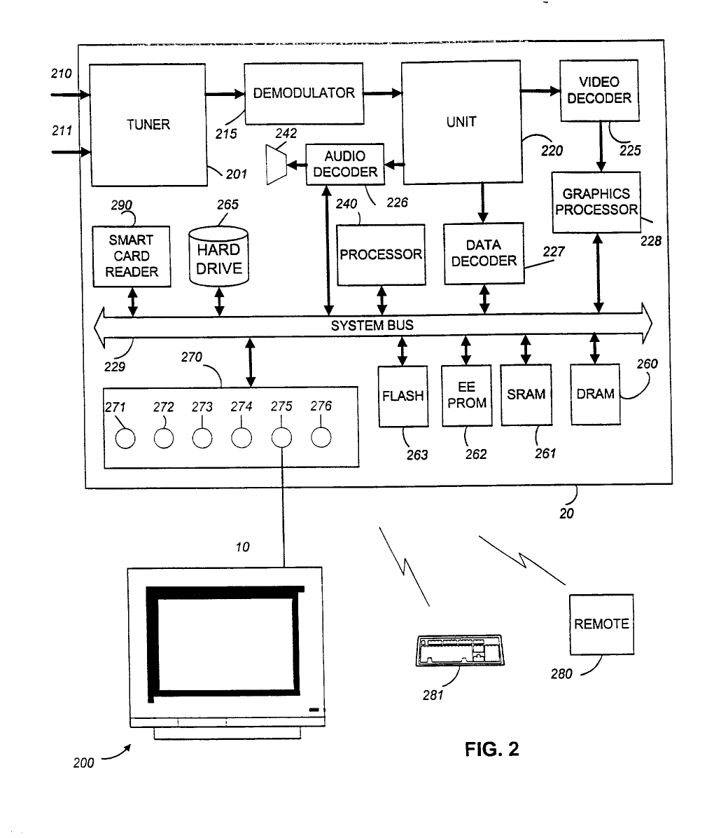

Referring to FIG. 2, an exemplary set top box system 200 includes a video display device 110 connected to a set top box 120. The set top box includes a tuner 201 that may receive quadrature amplitude modulation (QAM), orthogonal frequency division multiplexing (OFDM), and quadrature phase shift key (QPSK) digital TV signals 210. The digital TV signals 210 are received by the tuner 201 from various components, such as, for example, cable communications link 161 of system 100. Similarly, analog TV signals 211 are provided to the tuner 201 using various components, such as, for example, antenna 73 of system 100. The tuner 201 may be implemented using a broadcast in-band tuner, an out-of-band tuner, and a return path tuner. In addition, the TV tuner 201 may receive TV signals 210 or 211 from a video recorder/player device (e.g., a VCR, a DVD player, or a laser disc player) though a separate interface also may be provided for receiving these signals (as described in detail below). The tuner 201 generally isolates a physical channel from the received signal 210 or 211 and converts it to a baseband signal.

The analog baseband signal output from the tuner 201 is sent to a demodulator 215. The demodulator 215 samples an analog signal and converts it to a digital bit-stream (e.g., a Moving Pictures Experts Group (MPEG)-2 bit stream). The data may be organized in discrete units, such as, for example, data packets. The bit-stream may include video, audio, and other data. The bit-stream is checked for errors and is forwarded to a unit 220 that examines the packets in the bit-stream, selects particular packets, and forwards the packets to one or more of a video decoder 225, an audio decoder 226, or a data decoder 227.

The video decoder 225 transforms video packets into a sequence of pictures which may be displayed on the display device 110. The output from the video decoder 225 may be sent to an optional graphics processor 228 for enhanced TV and web content display. If a graphics processor is not included, the output of the video decoder 225 is sent directly to the system bus 229. The system bus 229 provides a communications path between the processor 240 and the various components of the set top box 120.

The audio decoder 226 decompresses an audio bit-stream received from the unit 220 and delivers the decompressed audio bit-stream to a speaker 242 or to the system bus 229.

The data decoder 227 is connected to the system bus 229 and decodes data packets received from the unit 220 or the system bus 229. The data decoder 227 uses the system bus 229 to deliver the decoded data packets for processing by a processor 240 or other set top box components.

The processor 240 operates according to any number of operating systems including those available from, for example, Power TV, VxWorks, pSOSystem, Microware, Microsoft, or Linux. The processor 240 provides a number of functions for the set top box 120. The processor 240 initializes the set-top box hardware, monitors and manages hardware interrupts, and fetches data and instructions from memory. The processor 240 also processes a range of web and TV content data. In addition, the processor 240 may execute various programs and applications, such as, for example, a browser, stored in the memory or storage of the set top box 120.

The set top box 120 may include a number of memories. For example, a random access memory (RAM) may be used as a temporary storage area for data flowing between the processor 240 and set top hardware. Dynamic RAM (DRAM) 260 and static RAM (SRAM) 261 are examples of memories that may be used. The DRAM 260 typically is used for interactive applications, while the SRAM 261 generally is used to support time sensitive applications, such as MPEG processing.

Non-volatile memory, such as an electrically erasable programming read only memory (EEPROM) 262 and a flash memory 263, also may be provided. The EEPROM 262 generally is used to store control programs and boot-up information for the processor 240. The flash memory 263 may be used to store programs and customer specific information. In addition, the flash memory 263 may be used to store data downloaded from the host 135 to provide additional functionality to the set top box 120 and to store temporary data that are continually updated.

The set top box 120 also may include one or more large-scale memory devices, such as a hard drive 265. The hard drive 265 may be used to store TV and web content, such as, for example, personal documents, favorite Internet sites, e-mail messages, recorded TV content, data files, audio files, video files, programs, and other data.

The set top box 120 may include a number of input/output (I/O) interfaces 270, such as, for example, including: a modem 271, a high-speed multimedia interface 272, a serial interface 273, a common interface 274, a TV and VCR interface 275, and a wireless interface 276 to wireless devices, such as a remote control 280 and/or a wireless keyboard 281. The set top box also may include a smart card reader 290. The I/O interfaces 270 provide a communications path between external devices and the system bus 229 to facilitate the exchange of data with the set top box 120. The set top box 120 may include one or more of these I/O interfaces 270.

The modem 271 facilitates two-way interactivity between the set top box 120 and the host 135 or a service provider (e.g., cable company 61). Once activated, the modem 271 can send a request to a web server on the Internet 130, download a file, send an e-mail message, and facilitate a two-way interactive service, such as home shopping or video-on-demand.

The high-speed multimedia interface 272 allows the set top box 120 to communicate in real time with other devices, such as a camcorder, a DVD player, a laser disk player, a CD player, and a digital camera. The high-speed interface 272 may be implemented using various hardware devices, such as, for example, an IEEE 1284 parallel port, a universal serial bus, and a 10/100 Base-T (i.e., Ethernet) device.

The serial interface 273 (e.g., an RS-232 interface) provides a serial communications interface that allows the set top box 120 to exchange data with other devices, such as, for example, a printer, a computer, a personal data assistant (PDA), or an external storage device.

The common interface 274 may provide a standardized interface to connect the set top box 120 with a separate hardware module, such as a personal computer memory card international association (PCMCIA) interface.

The TV and VCR interface 275 allows the set top box 120 to communicate with the display device 110 and a video recorder/player. The wireless remote control interface 276 receives control signals from a viewer interface device, such as, for example, a remote control device 280 and a wireless keyboard device 281. The control signals are interpreted by the processor 240 to activate and control functions of the set top box 120 and the display device 110. The viewer interface devices may communicate with the remote control interface 276 using RF signals, infrared signals, or otherwise.

The smart card reader 290 may read a smart card that contains, for example, identification information for authorizing access to the host 135, accessing the programming distribution service 180, or conducting an e-commerce transaction.

The set top box 120 constructs or formats a display for presentation on a screen of the display device 110. The display may be constructed from web content, TV content, or a combination of both web and TV content. A browser application (e.g., Liberate's TV navigator) being run by the processor 240 creates the display from outputs of the memories (e.g., DRAM 260, SRAM 261, and EEPROM 262), the hard disk 265, the I/O interfaces 270, and/or the decoders (e.g., video decoder 225, audio decoder 226, and data decoder 227). The browser can support a number of computing standards including, for example, hypertext markup language (HTML), Java, JavaScript, and hypertext transfer protocol (HTTP).

The browser integrates web and TV content by processing, for example, a window tag. A window tag is an HTML-like tag (e.g., <IMG SRC=“TV” x=0 y=0>) that instructs the browser to place TV content received by the set top box 120 on the screen of the display device 110 at specified coordinates. By modifying a received web page to include a window tag, the browser can display the TV content in conjunction with web content in windows designated for each type of content. Any number of content windows may be displayed on a screen at one time. In addition, the windows may be separate from or appear to overlap each other. Web content also may be assigned HTML-like tags indicating the arrangement of the web content on the screen. The screen of the display device 110 can be modified to insert user controls, resize the TV image, and provide interactive links by altering instructions of the web content displayed by the browser.

The set top box 120 also may present content that is overlaid with user interface controls or menus. The controls and menus may correspond to functions (e.g., tuning channels) performed by the set top box 120. Interactive controls and display windows also may be overlaid on the TV content or web content on the screen of the display device 110. One example of the combination of interactive displays overlaying TV content is described in U.S. application Ser. No. 09/365,734 filed Aug. 3, 1999, and titled “Providing Interactive Links in TV Programming,” which is incorporated by reference.

Determining and Presenting Dynamic Content

To help viewers access content of interest, the viewer's interactions with the set top box 120 may be monitored and analyzed. Content may be assembled, identified, generated, produced, and edited for presentation to a viewer based on the monitored and analyzed viewer interactions. As a result, content of interest to the viewer can be identified and made accessible to the viewer without any additional effort or knowledge required by the viewer.

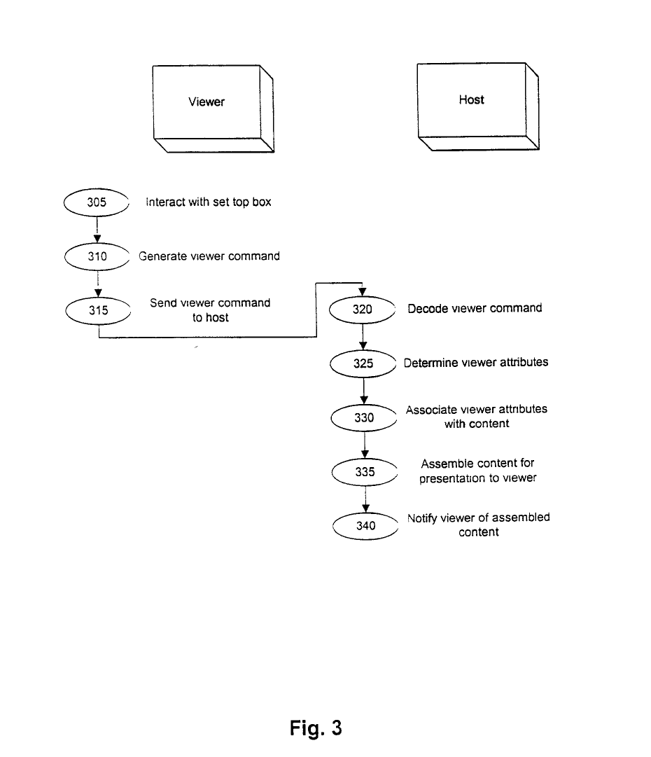

Referring to FIG. 3, the set top box system 100 operates according to a procedure 300. The procedure 300 may be implemented by any suitable type of hardware (e.g., device, computer, computer system, equipment, component); software (e.g., program, application, instructions, code); storage medium (e.g., disk, external memory, internal memory, propagated signal); or combination thereof.

In one implementation, a viewer interacts with the set top box 120 using a viewer input device (step 305). Examples of viewer input devices include a remote control 280, a keypad (not shown), and/or a wired or a wireless keyboard 281. The viewer controls functions of the set top box 120 by inputting commands from the viewer input device. For example, the viewer may command the set top box 120 to change channels, to select programming, to view web pages, to read email, to purchase items, to rate shows, to set reminders, to record programming, and to answer polls. The viewer also may input commands to control an EPG, such as, for example, to view programming information, to determine programming times and channels, to select programming, and to record programming.

In response to a viewer interaction, a viewer command is generated (step 310). The viewer command may be embodied in a signal that is sent from the viewer input device to the interface 275 and then over the system bus 229 to the processor 240. The processor 240 interprets the signal and implements one or more functions of the set top box 120 corresponding to the viewer command.

The viewer command may be saved in a storage of the set top box 120, for example, in a viewer file, in an input command cache, or in another storage location. Saved viewer commands may be transmitted periodically to the host 135. The processor 240 may transmit the commands at specified time intervals or based on other criteria. For example, viewer commands may be transmitted every few seconds, minutes, hours, days, weeks, or months. Different viewer commands may be transmitted at different intervals. In addition, commands may be discriminated such that only particular commands or types of commands may be sent. The host 135 also may actively poll the set top box 120 to transmit the saved commands.

Next, the viewer command is sent to the host 135 (step 315). A viewer command may be transmitted directly to the host 135 as the viewer command is implemented by the processor 240. The viewer command may be encoded in a TCP/IP packet and sent to the host 135 using the communications link 137. Tags and other data may be sent with the viewer command to identify the set top box, the viewer, and/or the household generating the viewer command.

After the host 135 receives the transmitted viewer commands, the host 135 decodes the viewer commands (step 320). In one implementation, decoding is performed to determine the viewer's interaction with the set top box 120. For example, a decoded viewer command may be used to determine the programming to which the set box 120 has been tuned, the channels to which the set top box has been tuned, the time the command was made, and the features of the set top box that have been used.

Next, the decoded viewer commands are analyzed to determine viewer attributes (step 325). In one implementation, viewer attributes are derived from the viewer's interaction with the set top box 120. For example, specific viewer interactions and/or patterns of interactions may be analyzed by the host 135 to identify the viewer's favorite programming, the viewer's favorite guides, the viewer's favorite type or genre of programming, the viewer's favorite viewing times, the viewer's favorite web pages or categories of web pages, the most frequently used functions of the set top box 120, whether the viewer uses interactive features of the set top box, and the viewer's favorite products and/or services. The analysis of the viewer commands also may be combined with conventional demographic analysis using the viewer's personal information.

Then, the viewer attributes are associated with content (step 330). In one implementation, the viewer attributes are used to identify, generate, assemble, and produce content of interest to the viewer. Content may be associated with viewer attributes based on any number of criteria, such as the number of viewers watching a program, whether the viewer is an interactive viewer, time of day of the program, program genre, and products, services, and advertising that are determined to appeal to a viewer. For example, using aggregate decoded viewer commands, the host 135 may determine that there are twenty thousand viewers of the TV program “Star Trek Voyager” on Monday evenings, that half of the viewers are regular interactive TV viewers, and that a third of the viewers watch other sci-fi shows (of which the most viewed show is “Babylon V”). Using this information, content may be identified, generated, and assembled for presentation to the viewer. For example, the content may include a special science fiction (“sci-fi”) EPG that may be generated and presented to viewers of Star Trek Voyager. The content also may include links to the Internet including, for example, web pages containing information about Star Trek Voyager and related products that may be purchased by the viewer. The content may include advertising related to the programming content or viewer's interests. For example, an advertisement for “Babylon V” may be displayed to the viewer. The content also may include interactive opportunities, such as, for example, chat rooms, games, and/or polls related to the viewer's interest.

Next, the content is assembled for presentation to the viewer (step 335). Content may be assembled for delivery to the viewer in a number of ways. In one approach, content may be assembled by one or more persons that review available content and create new content specifically tailored for a group of viewers based on the analyzed viewer commands. For example, a production staff may assemble content for a TV show, such as links to websites, information about programs' actors, actresses, and producers, fan websites, an interactive chat room, program guide information, statistics, advertisements, and products for delivery or presentation to the viewer. The display and arrangement of the content also may be specifically designed for the viewer. The production and arrangement of the content may be determined by the host 135, the program's producer, and/or the program's broadcaster.

Content also may be identified, assembled, generated, or produced automatically. For example, an automated search engine, an automated agent, and/or a programmed processor (or processors) may identify information that is related to a show, and retrieve content from websites and databases that may be presented to a viewer. The processor (or processors) may automatically create interactive polls, EPGs, and chatrooms based on viewer interest, participation, and content that has been identified to be of interest to the viewer. A combination of manually and automatically generated content also may be used. For example, content may be automatically identified by processors, and may be assembled for presentation by a production team.

The assembled content may be continually and dynamically updated and changed based on further analysis of the viewer's interaction with the set top box 120. Content may be added and updated as new content becomes available or may be deleted as old content becomes stale or outdated. In addition, content may be added, changed, assembled, or deleted based on continued analysis of viewer commands. For example, content that is not accessed by viewers may be deleted.

Finally, the viewer is notified of the assembled content (step 340). For example, once content has been identified and assembled for presentation, a trigger may be used to notify the viewer that additional content is available. A trigger is a real-time, or time stamped, notification of content, and is used to display an indication that content is available to the viewer. The trigger may be sent to the set top box 120 using any of the communications paths described above and shown in FIG. 1 (e.g., a broadcast signal, a satellite signal, or an online connection). The advanced TV enhancement forum (ATVEF) includes one standard for the use and application of triggers.

When the set top box 120 receives a trigger, a browser run by the processor 240 determines whether the trigger should be activated, or stored and activated at a later time. The trigger may be activated by a viewer's interaction with the set top box 120. For example, when the viewer commands the set top box 120 to perform a function, such as tuning to a show, the processor 240 determines if the action activates a trigger. If the trigger is activated, the processor 240 provides an indication to the viewer that additional content is available. Any number of events may be used to activate a trigger, such as, for example, a time or date, selecting a channel or a program, or selecting a feature of an EPG.

Attributes of triggers may include, for example, any of a URL, an event name, an application name, an expiration date, and a script. The URL is used to direct the browser as to where to retrieve content for display. The event name, such as “STAR TREK INTERACTIVE,” indicates the type of message that is displayed to the viewer. The application name is a pointer that may be used by the processor 240 to access an application stored in a storage of the set top box 120 that is to be executed upon activation of the trigger. The expiration date/time is used by the processor to determine when a trigger should not be activated and may be discarded.

The trigger also may include a script. The script is an embedded program that adds functionality to the trigger. The script may be programmed using an interpreted language, such as Javascript, in which commands are executed by the browser in the order in which the browser reads them. Scripts usually take the form of an object followed by a method for using the object, for example, opening a window on the screen to display a message. Parameters may be added, for example, to specify the size of the window and the font of text appearing in the window.

Several receiver components are used by the processor 240 to process a received trigger. The receiver components may include the following objects: state, source ID, release timer, return path, and content type. The state indicates whether the trigger should be enabled or disabled. The source ID allows the processor 240 to determine the source of the trigger. A release timer may be provided so that the processor 240 can determine when and how often to activate a trigger. For example, the trigger “INTERACTIVE STAR TREK” may be activated and displayed when the set top box is tuned to the program “Star Trek Voyager.” In addition, a return path is used by the processor 240 to establish a one or a two-way exchange of information with, for example, the host 135 to access content associated with the trigger. A content type indicates what kind of content is being triggered so that the processor 240 may take appropriate steps to present the content to the viewer, such as, for example, using a predetermined format. A detailed description of triggers and their implementation may be found in the above-referenced U.S. Application “Online/Offline Triggers.”

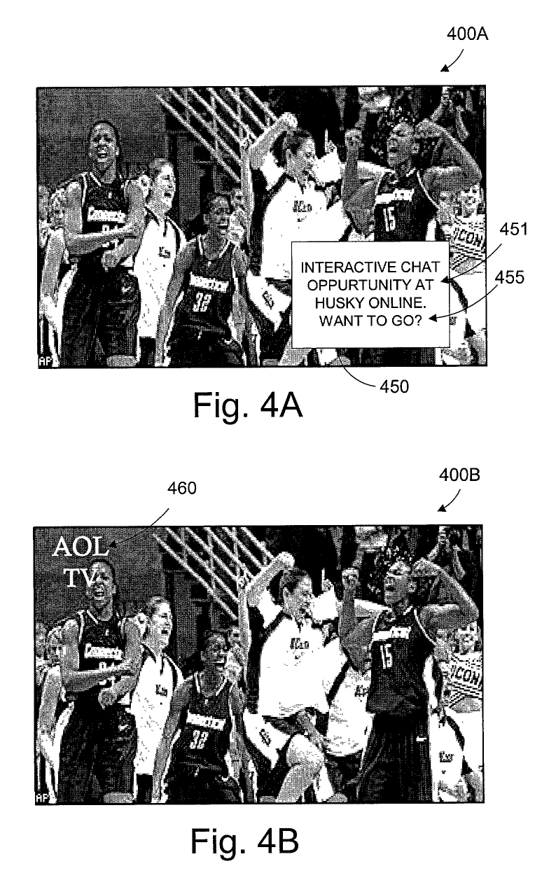

Once the trigger is activated, an indication of the content is displayed on the viewer's display screen. For example, FIG. 4A shows an exemplary display screen 400A that may display TV programming. Upon activation of a trigger, the processor 240 accesses the script associated with the trigger, or the application program specified by trigger, to generate a message window 450 that appears to overlay the TV content. The message window 450 may present the viewer with information and/or interactive opportunities 451. One or more interactive links 455 may be displayed in the message window 450 to connect the viewer with content or to activate functions of the set top box 120. The viewer may select the interactive link 455 using a viewer interface device. The message window 450 may appear for a predetermined period of time specified by the trigger or until the viewer interacts with the message window 450.

FIG. 4B shows an icon 460 that may be displayed on the screen 400B to indicate that additional content is available to the viewer. The viewer may access the content by selecting the icon 460 using a viewer input device. The icon 460 may be displayed for a predetermined period of time specified by the trigger. Selection of the icon 460 accesses the content associated with the icon 460.

If the viewer selects the interactive link 455 or the icon 460, the processor 240 accesses the content specified by the trigger. The content may be “pushed down” and/or “pulled down” to the set top box 120. When content is pushed-down, the content may be placed in TCP/IP packets and transmitted online from the host 135 to the set top box 120 using communications link 137. The packets are received and decoded by the processor 240 to assemble the content. The content may be stored in a storage of the set top box. When the interactive link 455 or icon 460 associated with a trigger is selected by the viewer, the processor accesses the stored content for display.

The content also may be pulled down from the host 135 to the set top box 120 using communications link 137. In this case, upon selection of the interactive link 455 or icon 460, the processor 240 sends a request for the content to the host 135. The host 135 responds and sends the content to the set top box 120 where it is processed for display by the processor 240.

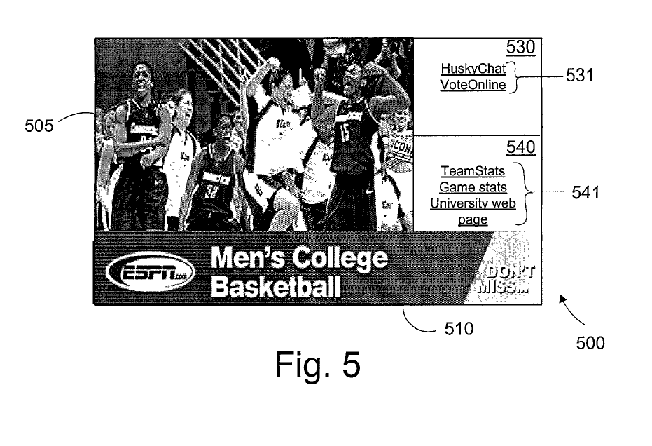

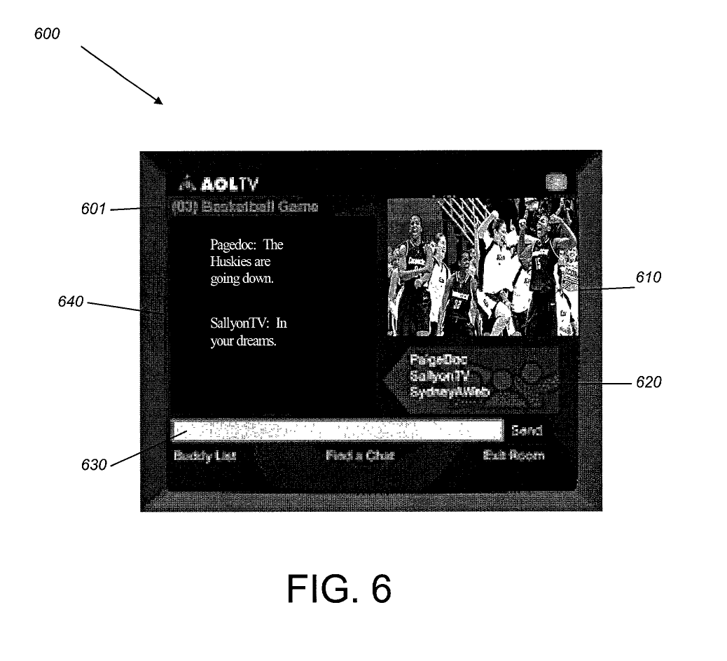

A browser run by processor 240 displays the content as described above. FIG. 5 shows an exemplary display screen 500 of content accessed by selecting the interactive link 455 or the icon 460. The display screen 500 may be divided into a number of related or unrelated viewing windows. Window 505 may display TV programming. Window 510 may display, for example, advertisements, tickers, news, and other information of potential interest to the viewer that has been identified and assembled based on the analyzed viewer input. Windows 530 and 540 may be used to display interactive events and information to the viewer. For example, window 530 may display interactive links 531, such as a link to a chat room or a viewer's poll. Window 540 may include a number of information links 441, such as a link to a web page.

The display screen 500 may be formatted for display by the processor 240. The browser determines how the windows and their related web and TV content are presented to the viewer on screen 500. Any number of windows may be displayed on the display screen 500. The windows may be arranged in a format specified by the host 135.

FIG. 5 shows another exemplary display screen 600 for an interactive chat that may be accessed by selecting the interactive link 531 “HuskyChat” using a viewer input device. The display screen shows the selected channel 601, and the TV content of the channel 601 is displayed in window 610. Users may be automatically added to the chat room by selecting the link 531. A list of the viewers in the chat room is displayed in window 620. The viewer may enter comments for the chat room using the data entry area 630. The interactive chat is displayed in window 640.

According to the various implemenations described above, content of interest to the viewer may be identified, generated, assembled, and presented to the viewer. The content is dynamic and may be continually updated based on changing viewer interaction and interest. In addition, the content is not restricted to TV programming. The viewer also is not required to perform any additional activities, such as filling out questionnaires, or using search engines. The viewer does not have to learn additional commands or functions of the set top box. As a result, the system is very easy to use.

A number of implementations have been described. Nevertheless, it will be understood that various modifications may be made. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method for providing content to a viewer, the method comprising:
receiving a signal from a set top box;
determining a viewer command associated with the signal;
analyzing the viewer command to determine content of potential interest to the viewer; and
assembling the determined content for presentation to the viewer.

2. The method of claim 1 further comprising:
generating a trigger to indicate that the assembled content is available for viewing; and
sending the trigger to the set top box.

3. The method of claim 2 further comprising:
receiving a signal from the set top box to access the content; and
sending the content to the set top box.

4. The method of claim 2 wherein the trigger is activated in response to viewer interaction with the set top box.

5. The method of claim 1 wherein viewer commands are analyzed to determine the content.

6. The method of claim 4 wherein the viewer commands of more than one viewer are analyzed to determine the content.

7. A system for providing content to a viewer, the system comprising:
an interface for receiving a signal from a set top box; and
a host for determining a viewer command associated with the signal, analyzing the viewer command to determine content of potential interest to the viewer, and assembling the determined content for presentation to the viewer.

8. The method of claim 7 wherein the host generates a trigger to indicate the assembled content is available for viewing and sends the trigger to the set top box.

9. The method of claim 8 wherein the host receives a signal from the set top box to access the content and the host sends the content to the set top box.

10. The method of claim 8 wherein the trigger is activated in response to viewer interaction with the set top box.

11. The method of claim 7 viewer commands are analyzed to determine the content.

12. The method of claim 11 wherein the viewer commands of more than one viewer are analyzed to determine the content.

13. A method for displaying content to a viewer, the method comprising:
receiving a viewer command;
sending the viewer command to be analyzed; and
receiving content based on the analyzed commands,
wherein the content is selected based on analysis of the viewer command to determine content of potential interest to the viewer.

14. The method of claim 13 further comprising:
receiving a trigger to indicate that the content is available for viewing; and
displaying an indication that the content is available when the trigger is activated.

15. The method of claim 14 further comprising:
receiving a signal from a viewer input device to access the content; and
displaying the content.

16. The method of claim 15 further comprising accessing a memory of the set top box to retrieve the content for display.

17. The method of claim 15 further comprising sending a signal to request the content and receiving the content.

18. The method of claim 14 wherein the trigger is activated in response to viewer interaction with the set top box.

19. The method of claim 13 wherein viewer commands are analyzed to determine the content.

20. The method of claim 19 wherein the viewer commands of more than one viewer are analyzed to determine the content.

21. A set top box comprising:
a display interface configured to output display data;
an input configured to receive a viewer command;
a command interface configured to send the viewer command to be analyzed;
a content interface configured to receive content; and
a processor configured to cause the display interface to display the content received by the content interface, wherein the content is selected based on analysis of the viewer command to determine content of potential interest to the viewer.

22. The set top box of claim 21 wherein the processor is configured to process a trigger that indicates that the content is available for viewing and to send an indication that the content is available to the display interface when the trigger is activated.

23. The set top box of claim 22 wherein the processor is configured to process a signal from viewer command input to access the content and to send the content to the display interface for display.

24. The set top box of claim 23 further comprising a memory configured to store the content, wherein the processor is configured to access the memory to retrieve the content.

25. The set top box of claim 23 wherein the processor is configured to send a signal to request the content.

26. The set top box of claim 22 wherein the trigger is activated in response to viewer interaction with the set top box.

27. The set top box of claim 21 wherein viewer commands are analyzed to determine the content.

28. The set top box of claim 27 wherein the viewer commands viewer are analyzed to determine the content.
